(19) United States
(12) Patent Application Publication
(10) Pub. No.: US 2025/0149981 A1
(43) Pub. Date: May 8, 2025

(54) TRANSFORMER ASSEMBLIES AND TRANS-INDUCTANCE VOLTAGE REGULATORS

(71) Applicant: Infineon Technologies Austria AG, Villach (AT)

(72) Inventors: Roberto RIZZOLATTI, Villach (AT); Luca PELUSO, Villach (AT); Gerald J. DEBOY, Klagenfurt (AT)

(21) Appl. No.: 18/500,235

(22) Filed: Nov. 2, 2023

(51) Int. Cl. H02M 3/158; H01F 27/24; H01F 27/28; H01F 41/04

(52) U.S. Cl. CPC H02M 3/158; H01F 27/24; H01F 27/28; H01F 41/04

(57) ABSTRACT

A power converter assembly for transformer assembly as discussed herein may include multiple electrically conductive paths such as a first electrically conductive path, a second electrically conductive path, and a third electrically conductive path. The first electrically conductive path extends through the magnetically permeable material. The second electrically conductive path extends through the magnetic permeable material. The second electrically conductive path is inductively coupled to the first electrically conductive path via the magnetically permeable material. The third electrically conductive path is disposed in the magnetically permeable material and extends along the first electrically conductive path and the second electrically conductive path.

### BACKGROUND

A printed circuit board (PCB) or printed wiring board is a laminated structure of conductive layers separated by insulating layers. In general, PCBs have two functions. The first is to secure electronic components at designated locations on the outer layers of the PCB by means of affixing such as soldering. The electronic circuit instantiated by the populated circuit board is designed to provide one or more specific functions. After fabrication, the electronic circuit is powered to perform the desired functions.

Typically, a printed circuit board is a planar device on which multiple components are interconnected via traces to provide the functions as previously discussed. Such implementations of fabricating circuitry on a planar circuit board assembly is dimensionally limited, preventing high density implementation of circuitry.

Modern VR (Voltage Regulator) modules for high power demanding applications (such as AI training processors and TPU based data-centers) can be distinguished in two categories based on the way the heat generated by the semiconductor devices is sank out of the module towards the heatsink.

Conventional power stage cooled modules include physical stack-up of components, enabling a direct contact between the power stage itself (such as including a set of semiconductor devices and the package embedding it) and the heatsink which is the most effective way to sink the generated heat out and therefore leading to a very low Rth (thermal resistance, the lower the better).

It is further noted that a conventional TLVR (Trans-inductance Voltage Regulator) system is generally a voltage regulator (e.g. a buck converter) where the magnetic device is no longer a single-winding inductor, but a transformer with two windings; where the primary windings constitute the phase inductors. The secondary windings are the so called TLVR windings, which are used to improve the transient performance. The secondary windings of each phase are series connected and their routing with respect to a PCB (Printed Circuit Board) ensures that the transformer dots rule is always fulfilled.

### BRIEF DESCRIPTION

Implementation of clean energy (or green technology) is very important to reduce our impact as humans on the environment. In general, clean energy includes any evolving methods and materials to reduce an overall toxicity of energy consumption on the environment.

This disclosure includes the observation that raw energy, such as received from green energy sources or non-green energy sources, typically needs to be converted into an appropriate form (such as desired AC voltage, DC voltage, etc.) before it can be used to power end devices such as servers, computers, mobile communication devices, etc. Regardless of whether energy is received from green energy sources or non-green energy sources, it is desirable to make most efficient use of raw energy provided by such systems to reduce our impact on the environment. This disclosure contributes to reducing our carbon footprint (and green energy) via more efficient energy conversion and circuit implementations supporting same.

As discussed herein, a fabricator produces one or more assemblies to provide higher density circuitry and better heatsink capability than provided by conventional instantiation of circuitry on planar circuit boards.

More specifically, this disclosure includes an apparatus, systems, methods, etc. For example, a power converter assembly or transformer assembly as discussed herein may include multiple electrically conductive paths such as a first electrically conductive path, a second electrically conductive path, and a third electrically conductive path. The first electrically conductive path extends through the magnetically permeable material. The second electrically conductive path extends through the magnetic permeable material. The second electrically conductive path is inductively coupled to the first electrically conductive path via the magnetically permeable material. The third electrically conductive path is disposed in the magnetically permeable material and extends along the first electrically conductive path and the second electrically conductive path.

In accordance with further examples, a first portion of the third electrically conductive path is inductively coupled to the first electrically conductive path; and a second portion of the third electrically conductive path is inductively coupled to the second electrically conductive path.

Still further examples as discussed herein include a configuration in which: i) a first portion of the third electrically conductive path and the first electrically conductive path is a first transformer of a trans-inductance voltage regulator circuit; and ii) a second portion of the third electrically conductive path and the second electrically conductive path is a second transformer of the trans-inductance voltage regulator circuit.

The transformer assembly and/or power converter assembly as discussed herein can be configured to include: first switch circuitry operative to control a magnitude of first current supplied into a first axial end of the first electrically conductive path, the first current being conveyed by the first electrically conductive path to a second end of the first electrically conductive path; and second switch circuitry operative to control a magnitude of second current supplied into a first axial end of the second electrically conductive path, the second current being conveyed through the second electrically conductive path to a second end of the second electrically conductive path. An electrically conductive element associated with the transformer assembly provides coupling of the second axial end of the first electrically conductive path to the second axial end of the second electrically conductive path. The electrically conductive element outputs an output voltage.

In another example, the first electrically conductive path in the transformer assembly is a first inductor; the second electrically conductive path in the transformer assembly is a second inductor; and the first inductor is inversely coupled with respect to the second inductor in the transformer assembly.

Further, the magnetically permeable material in the transformer assembly can be configured to include a gap disposed in a first volume of the magnetically permeable material. The first volume is disposed between the first electrically conductive path and the second electrically conductive path. Note that the gap can be a void or filled with any suitable material.

In another example, the transformer assembly as described herein may include a first gap disposed in the magnetically permeable material. The first gap may be disposed in a first volume between the first electrically conductive path and the second electrically conductive path. The transformer assembly as described herein can be configured to include a second gap disposed in the magnetically permeable material; the first electrically conductive path disposed in a second volume between the first gap and the second gap. The transformer assembly as described herein can be configured to include a third gap disposed in the magnetically permeable material, the second electrically conductive path disposed between the first gap and the third gap.

In yet another example, a combination of the magnetically permeable material, the first electrically conductive path, the second electrically conductive path, and the third electrically conductive path are disposed in a transformer assembly. The apparatus and/or transformer assembly as further discussed herein can be configured to include a first substrate; the transformer assembly may be affixed to the first substrate. The transformer assembly can be configured to include first switch circuitry on a second substrate, the first switch circuitry operative to control flow of first current through the first electrically conductive path and the second electrically conductive path. The combination of the magnetically permeable material, the first electrically conductive path, the second electrically conductive path, and the third electrically conductive path may be disposed between the first substrate and the second substrate. The power converter assembly as described herein can be configured to include a heatsink coupled to the first substrate.

In yet a further example, the first electrically conductive path is disposed in parallel with the second electrically conductive path. The power converter assembly may be configured to include first switch circuitry operative to control first current to flow in a first direction through the first electrically conductive path and second switch circuitry operative to control second current to flow in a second direction through the second electrically conductive path. The second direction may be substantially opposite the first direction. The apparatus as described herein may further include an electrically conductive element operative to convey a summation of the first current and the second current to a load.

In still a further example, the magnetically permeable material can be configured to support conveyance of first magnetic flux around a combination of the first electrically conductive path and the second electrically conductive path; the magnetically permeable material can be configured to support conveyance of second magnetic flux around a combination of the first electrically conductive path and a first portion of the third electrically conductive path, the second magnetic flux passing between first electrically conductive path and the second electrically conductive path; and the magnetically permeable material can be configured to support conveyance of third magnetic flux around a combination of the second electrically conductive path and a second portion of the third electrically conductive path, the third magnetic flux passing between the first electrically conductive path and the second electrically conductive path.

Further, the apparatus as discussed herein can be configured to include: a substrate; first switch circuitry affixed to the substrate, the first switch circuitry operative to control flow of first current through the first electrically conductive path; and second switch circuitry affixed to the substrate, the second switch circuitry operative to control flow of second current through the second electrically conductive path. The apparatus may further include: a first electrically conductive element extending between a first axial end of the first electrically conductive path to the first switch circuitry; a second electrically conductive element extending between a second axial end of the first electrically conductive path to the substrate; a third electrically conductive element extending between the first axial end of the second electrically conductive path to the second switch circuitry; and a fourth electrically conductive element extending between the second axial end of the second electrically conductive path to the substrate.

In another example herein, a combination of the magnetically permeable material, first electrically conductive path, the second electrically conductive path, and the third electrically conductive path are disposed in a transformer assembly. The apparatus may further include: a substrate to which the transformer assembly is affixed; and a layer of electrically conductive material. In such an instance, the transformer assembly may be disposed between the substrate and the layer of electrically conductive material. The apparatus may further include an electrically conductive element extending between the layer of electrically conductive material and the substrate; one or more electrically conductive elements can be configured to convey a respective output voltage produced by the first electrically conductive path and the second electrically conductive path to the substrate.

In accordance with a further example, this disclosure includes a method comprising: receiving magnetically permeable material; fabricating a first electrically conductive path to extend through magnetically permeable material; fabricating a second electrically conductive path to extend through the magnetically permeable material, the second electrically conductive path inductively coupled to the first electrically conductive path via the magnetically permeable material; and fabricating a third electrically conductive path disposed in the magnetically permeable material, the third electrically conductive path operable to extend along the first electrically conductive path and the second electrically conductive path.

Additionally, note that although each of the different features, techniques, configurations, etc., herein may be discussed in different places of this disclosure, it is intended, where suitable, that each of the concepts can optionally be executed independently of each other or in combination with each other. Accordingly, the one or more present inventions as described herein can be embodied and viewed in many different ways.

Also, note that this preliminary discussion of techniques herein (BRIEF DESCRIPTION) purposefully does not specify every novel aspect of the present disclosure or claimed invention(s). Instead, this brief description only presents general aspects and corresponding points of novelty over conventional techniques. For additional details and/or possible perspectives (permutations) of the invention(s), the reader is directed to the Detailed Description section (which is a summary) and corresponding figures of the present disclosure as further discussed below.

### BRIEF DESCRIPTION OF THE DRAWINGS

FIG. 1 is an example 3-dimensional diagram illustrating electrically conductive paths associated with a transformer assembly as described herein.

FIG. 2 is an example 3-dimensional diagram illustrating a transformer assembly as described herein.

FIG. 3 is a side view diagram illustrating flow of magnetic flux in a transformer assembly as described herein.

FIG. 4 is an example diagram illustrating a circuit equivalent of the transformer assembly as described herein.

FIG. 5 is an example diagram illustrating switch circuitry associated with each power converter phase as described herein.

FIG. 6 is an example 3-dimensional diagram illustrating implementation of a transformer assembly as described herein.

FIG. 7 is an example diagram illustrating a respective trans-inductance voltage regulator circuit including implementation of multiple power converter assemblies as described herein.

FIG. 8 is an example diagram illustrating implementation of a respective trans-inductance voltage regulator circuit as described herein.

FIG. 9 is an example diagram illustrating multiple views of a respective transformer assembly and/or power converter assembly as described herein.

FIG. 10 is an example diagram illustrating multiple views of a respective transformer assembly and/or power converter assembly as described herein.

The foregoing and other objects, features, and advantages of the disclosed matter herein will be apparent from the following more particular description herein, as illustrated in the accompanying drawings in which like reference characters refer to the same parts throughout the different views. The drawings are not necessarily to scale, with emphasis instead being placed upon illustrating the principles, concepts, aspects, techniques, etc.

### DETAILED DESCRIPTION

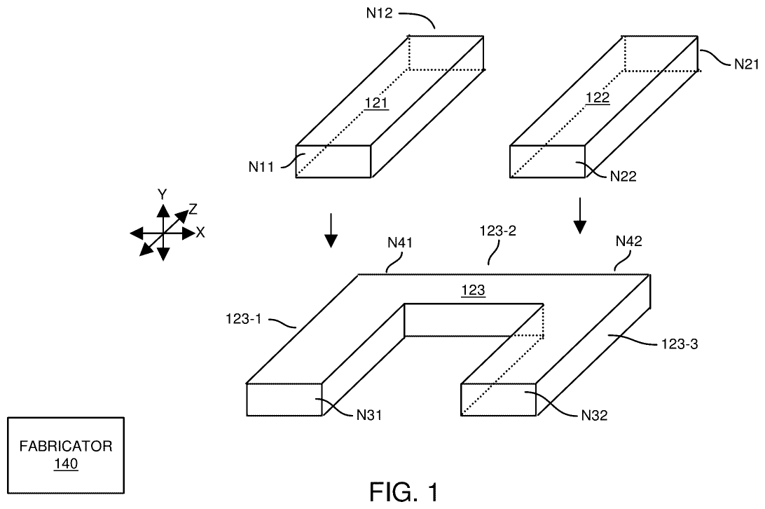

Now, more specifically, FIG. 1 is an example 3-dimensional exploded diagram illustrating electrically conductive paths associated with a transformer assembly as described herein.

In this example, the fabricator 140 creates and/or receives the electrically conductive path 121 and electrically conductive path 122. Additionally, the fabricator 140 creates and/or receives the electrically conductive path 123.

As shown, the electrically conductive path 121 (such as fabricated from metal other suitable electrically conductive material) extends axially along the z-axis from the first axial end N11 (also known as node N11) to the second axial end N12 (also known as node N12).

In a similar manner, the electrically conductive path 122 (such as fabricated from metal or other suitable electrically conductive material) extends axially along the z-axis from the first axial end N21 (also known as node N21) to the second axial end N22 (also known as node N22).

As further shown, the electrically conductive path 123 (extending along multiple different axes including the z-axis and the y-axis) includes multiple portions such as electrically conductive path 123-1, electrically conductive path 123-2, and electrically conductive path 123-3.

As previously discussed, the different portions of the electrically conductive path 123 extend axially in multiple directions. For example, a first portion (electrically conductive path 123-1) of the electrically conductive path 123 extends axially along the z-axis. The second portion (electrically conductive path 123-2) of the electrically conductive path 123 extends axially along the x-axis. The third portion (electrically conductive path 123-3) of the electrically conductive path 123 extends axially along the z-axis.

Note that the electrically conductive path 123 can be configured as homogeneous or heterogeneous material of connected paths (electrically conductive path 123-1, electrically conductive path 123-2, and electrically conductive path 123-3).

As further shown, and as further discussed herein, one aspect of creating a respective transformer assembly as discussed herein includes alignment of the electrically conductive path 121 with respect to the electrically conductive path 123-1. The fabricator 140 can be configured to provide an insulation layer (such as non-electrically conductive material) between the electrically conductive path 121 and the electrically conductive path 123-1 to avoid a short-circuit condition. Similarly, another aspect of creating a respective assembly as discussed herein includes alignment of the electrically conductive path 122 with respect to the electrically conductive path 123-3. The fabricator 140 can be configured to provide an insulation layer (such as non-electrically conductive material) between the electrically conductive path 122 and the electrically conductive path 123-3 to avoid a short-circuit condition.

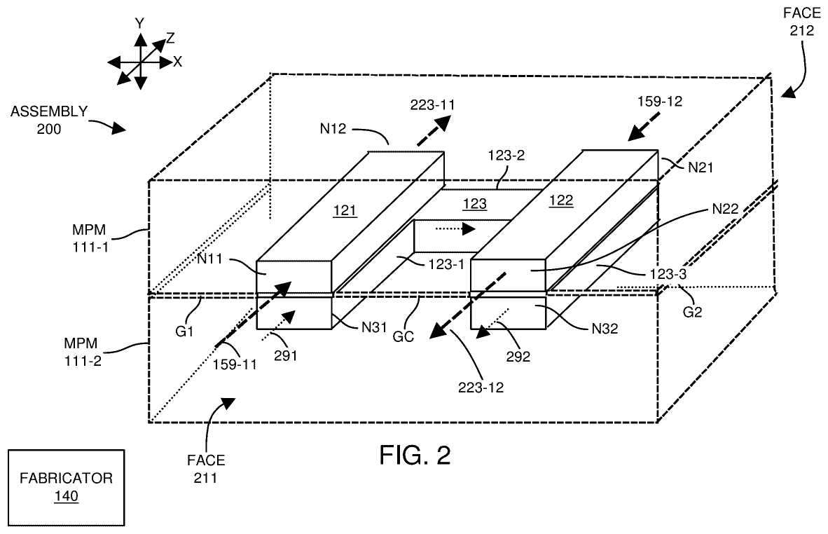

A further example of producing a respective transformer assembly 200 shown in FIG. 2.

FIG. 2 is an example 3-dimensional diagram illustrating a transformer assembly as described herein.

In addition to receiving and/or fabricating the first electrically conductive path 121, the second electrically conductive path 122, and the third electrically conductive path 123, the fabricator 140 receives and/or produces a structure such as including one or more components of magnetically permeable material 111.

For example, the magnetically permeable material 111 may include multiple portions of magnetic permeable material such as magnetically permeable material 111-1 and magnetically permeable material 111-2 to create the corresponding transformer assembly 200.

As previously discussed, the electrically conductive path 121 in the transformer assembly 200 is spaced apart with respect to the electrically conductive path 123-1 via a void or layer of electrically nonconductive material (such as an insulator material). This prevents the electrically conductive path 121 from being shorted to the electrically conductive path 123-1. In a similar manner, the electrically conductive path 122 in the assembly 200 is spaced apart with respect to the electrically conductive path 123-3 via a void or layer of electrically nonconductive material (such as an insulator).

As further shown, the fabricator 140 produces the transformer assembly 200 based on fabricating a first electrically conductive path 121 to extend through magnetically permeable material 111 (such as a combination of the magnetically permeable material 111-1 and the magnetically permeable material 111-2).

Note that the respective axial ends or nodes of the electrically conductive path 121 may terminate at a corresponding facing of the transformer assembly 200 (or magnetically permeable material 111) or may extend beyond the corresponding facings.

For example, fabricator 140 can be configured to terminate the node N11 associated with the electrically conductive path 121 at the face 211 (such as surface) of the transformer assembly 200 and/or magnetically permeable material 111. Alternatively, the node N11 and corresponding portion of the electrically conductive path 121 may protrude from the corresponding face 211 of the assembly 200 and/or magnetically permeable material 111.

In a similar manner, the fabricator 140 can be configured to terminate the node N12 associated with the electrically conductive path 121 at the face 212 (such as surface) of the transformer assembly 200 or magnetically permeable material 111. Alternatively, the node N12 and corresponding portion of the electrically conductive path 121 may protrude from the corresponding face 212 of the transformer assembly 200 or magnetically permeable material 111.

As further shown, the fabricator 140 produces the transformer assembly 200 based on fabricating a second electrically conductive path 122 to extend through magnetically permeable material 111 (such as a combination of the magnetically permeable material 111-1 and the magnetically permeable material 111-2).

Note that the respective axial ends of the electrically conductive path 122 may terminate at a corresponding facing of the transformer assembly 200 or may extend beyond the corresponding facings.

For example, fabricator 140 can be configured to terminate the node N21 associated with the electrically conductive path 122 at the face 212 (such as surface) of the transformer assembly 200. Alternatively, the node N21 and corresponding portion of the electrically conductive path 122 may protrude from the corresponding face 212 of the assembly 200.

In a similar manner, the fabricator 140 can be configured to terminate the node N22 associated with the electrically conductive path 122 at the face 211 (such as surface) of the transformer assembly 200. Alternatively, the node N22 and corresponding portion of the electrically conductive path 122 may protrude from the corresponding face 211 of the transformer assembly 200.

As further discussed during, the transformer assembly 200 can be configured to include additional electrically conductive elements to provide conductivity of each of the nodes associated with the transformer assembly 200 to other nodes in a respective power converter assembly.

Note again that the second electrically conductive path 122 is inductively (a.k.a., magnetically) coupled to the first electrically conductive path 121 via the magnetically permeable material 111.

As further shown, the fabricator 140 produces the transformer assembly 200 based on disposing a third electrically conductive path 123 in the magnetically permeable material 111. As previously discussed, the third electrically conductive path 123 is disposed in the transformer assembly 200 and extends along both the first electrically conductive path 121 and the second electrically conductive path 122.

More specifically, the first electrically conductive path 121 is disposed in parallel with and along the electrically conductive path 123-1. The second electrically conductive path 123-2 is disposed in parallel with and along the electrically conductive 123-3.

Accordingly, in this example, the first portion 123-1 of the third electrically conductive path 123 is inductively coupled to the electrically conductive path 121. The second portion 123-3 of the electrically conductive path 123 is inductively coupled to the electrically conductive path 122.

Note that the coupling of the first electrically conductive path 121 to the electrically conductive path 123 is inverse with respect to the coupling of the second electrically conductive path 122 to the electrically conductive path 123.

Yet further, as discussed herein, the first portion 123-1 (such as a secondary winding) of the electrically conductive path 123 and the electrically conductive path 121 (such as a primary winding) represent a first transformer (T12) in the assembly 200. As further discussed herein, the first transformer can be used to implement a corresponding trans-inductance voltage regulator and/or trans-inductance voltage power converter. Additionally, a second portion 123-3 (such as a secondary winding) of the electrically conductive path 123 and the electrically conductive path 122 (such as a primary winding) represents a second transformer (T13) in the assembly 200. The second transformer can be used to implement a corresponding trans-inductance voltage regulator circuit and/or trans-inductance voltage power converter.

As previously discussed, the electrically conductive path 121 can be inductively or magnetically coupled to the electrically conductive path 122. In one example, this creates a corresponding transformer T11 as further discussed herein.

Still further as discussed herein, the assembly 200 can be implemented in a respective power converter in which first switch circuitry of the power converter is operative to control first current 159-11 to flow in a first direction (along the z-axis) from the node N11 through the first electrically conductive path 121 to the node N12. As further discussed during, the output current 223-11 from the node N12 produces a respective output voltage 223 to power a load. Yet further, as discussed herein, the assembly 200 can be implemented in a respective power converter in which second switch circuitry of the power converter is operative to control second current 159-12 to flow in a second direction (along a z-axis) from the node N21 through the second electrically conductive path 122 to the node N22. The output current 223-12 from the node N22 also produces the respective output voltage 223 to power a load. In this example, the second direction (along a first direction the z-axis) of current flowing through the electrically conductive path 122 is opposite the first direction (along a second direction of the z-axis) of current flowing through the electrically conductive path 121.

Accordingly, the assembly 200 as described herein can be configured to include: i) a first electrically conductive path 121 extending through magnetically permeable material 111; ii) a second electrically conductive path 122 extending through the magnetically permeable material 111, the second electrically conductive path 122 being inductively coupled to the first electrically conductive path 121 via the magnetically permeable material 111; and iii) a third electrically conductive path 123 disposed in the magnetically permeable material 111 and extending along the first electrically conductive path 121 and the second electrically conductive path 122.

Yet further, note that the assembly 200 can be configured to include one or more gaps in the magnetically permeable material 111 between the magnetically permeable material 111-1 and the magnetically permeable material 111-2.

For example, the magnetic permeable material 111 can include a gap GC (such as center gap or layer of material) disposed between the magnetic permeable material 111-1 and the magnetically permeable material 111-2. The layer associated with the gap GC is disposed in the X-Z plane. Additionally, note that the gap GC resides in a volume disposed between a combination of the electrically conductive path 121 and the electrically conductive path 123-1 and a combination of the electrically conductive path 122 and the electrically conductive path 123-3.

Note that the gap GC can be any suitable material or it can be a void such as no material. Note further that the width or thickness of the gap GC along the y-axis can be adjusted to control an amount of magnetic coupling between the electrically conductive path 121 and the electrically conductive path 123-1 as well as the magnetic coupling between the electrically conductive path 122 and the electrically conductive path 123-3. Note further that the spacing of the electrically conductive path 121 and the electrically conductive path 122 along the X axis controls a degree to which the electrically conductive path 121 is magnetically coupled to the electrically conductive path 122.

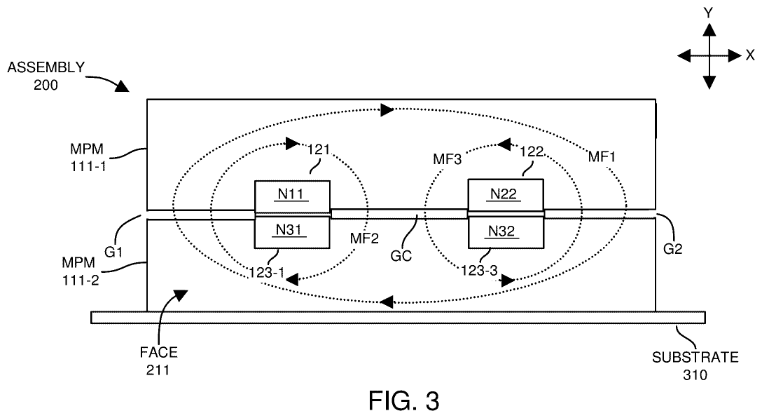

Additionally, the assembly 200 includes lateral gap G1 (disposed in the XZ plane) and lateral gap G2 (disposed in the XZ plane) disposed between the magnetic permeable material layers such as magnetically permeable material 111-1 and magnetically permeable material 111-2. Note that the lateral gaps G1 and G2 can be a void in which there is no material or the lateral gaps G1 and G2 can be filled in with any suitable material. Additionally, note that the gap G1 and gap G2 can be implemented or placed in any position within the flux paths in FIG. 3, not only in the X-Z plane but also X-Y plane, and so on.

As previously discussed, a thickness of each of the respective gaps G1, GC, and G2 can be controlled to control a respective coupling between the electrically conductive paths.

FIG. 3 is a side view diagram illustrating flow of magnetic flux in a transformer assembly as described herein.

As shown in the side view of the assembly 200 affixed (attached) to the corresponding substrate 310 in FIG. 3, the portions of magnetically permeable material 111 (such as magnetically permeable material 111-1 and magnetically permeable material 111-2) support conveyance of first magnetic flux MF1 (such as associated with transformer T11) around a combination of the first electrically conductive path 121 and the second electrically conductive path 122. In such an instance, based on the magnetic flux MF1, the electrically conductive path 121 is inductively or magnetically coupled to the electrically conductive path 122.

Further, the magnetically permeable material 111 is operative to support conveyance of second magnetic flux MF2 (such as associated with transformer T12) around a combination of the first electrically conductive path 121 and the first portion of the third electrically conductive path 123-1. Note that the second magnetic flux MF2 passes between the electrically conductive path 121 and the electrically conductive path 122. In such an instance, the electrically conductive path 121 is inductively or magnetically coupled to the electrically conductive path 123-1.

Yet further, the magnetically permeable material 111 is operative to support conveyance of the third magnetic flux MF 3 (such as associated with transformer T1 3) around a combination of the second electrically conductive path 122 and the electrically conductive path 123-3. The third magnetic flux MF3 passes between first electrically conductive path 121 and the second electrically conductive path 122. Accordingly, the magnetically permeable material 111 is operative to support conveyance of third magnetic flux MF3 (such as associated with transformer T13) around a combination of the second electrically conductive path 122 and the second portion 123-3 of the third electrically conductive path 123, the third magnetic flux MF3 passes between the first electrically conductive path 121 and the second electrically conductive path 122.

As previously discussed, note again that the gap G1 and gap G2 can be implemented and-or placed in any position within the flux paths MF1, MF2, MF3, etc., in FIG. 3.

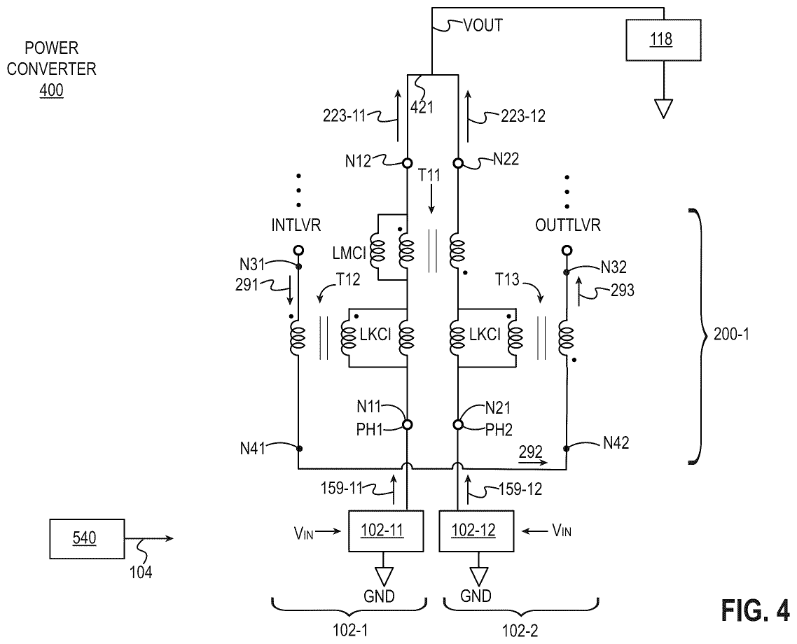

The corresponding logical circuit associated with the assembly 200 is further shown in FIG. 4.

FIG. 4 is an example diagram illustrating a circuit equivalent of the transformer assembly as described herein.

In this example, the power converter 400 includes an instance of the transformer assembly 200 (such as transformer assembly 200-1). Additionally, the power converter 400 includes corresponding switch circuitry 102-11 operative to control a magnitude of first current 159-11 supplied into the first axial end N11 of the first electrically conductive path 121. The first current 159-11 supplied at the first axial end N11 (or node ph1 in this case) of the first electrically conductive path 121 is conveyed through the first electrically conductive path 121 to a second end N21 of the first electrically conductive path 121.

The power converter 400 includes corresponding switch circuitry 102-12 operative to control a magnitude of second current 159-12 supplied into the first axial node N21 of the second electrically conductive path 122. The second current 159-12 supplied at the first axial end (such as node N21) of the second electrically conductive path is conveyed through the second electrically conductive path 122 to a second end (such as node N22) of the second electrically conductive path 122.

In accordance with further examples, an electrically conductive element 421 couples the second axial end (N12) of the first electrically conductive path 121 to the second axial end (N22) of the second electrically conductive path 122. The electrically conductive element 421 conveys and outputs a combination of the output current 223-11 and the output current 223-12 to produce the corresponding generated output voltage Vout to power a respective load 118.

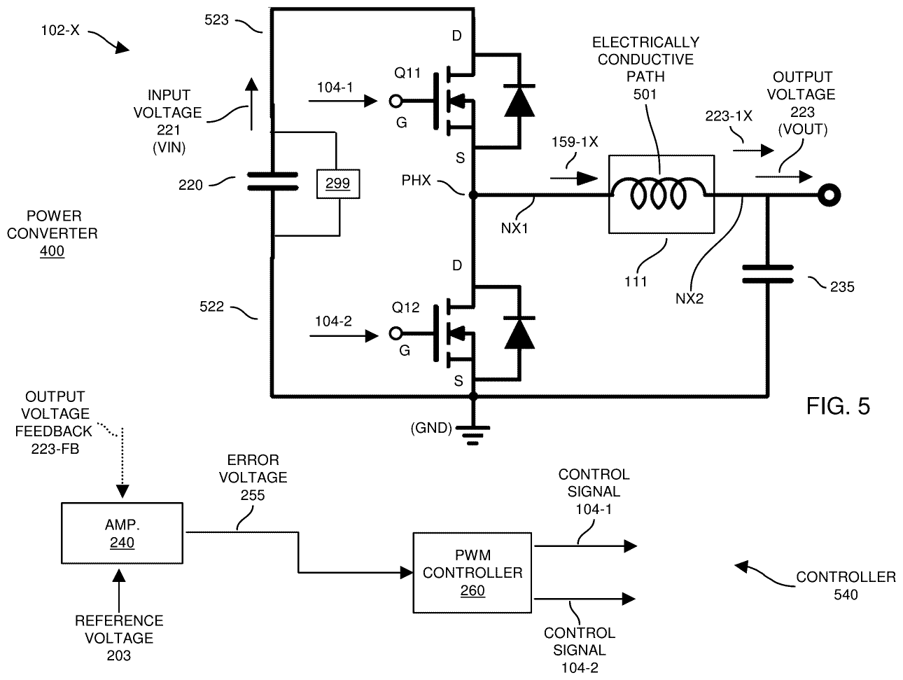

FIG. 5 is an example diagram illustrating implementation of a power converter phase to provide power to a dynamic load as discussed herein.

In this non-limiting example, the power supply circuit assembly or instance of the power converter 102-X is configured as a buck converter including input voltage source 220 (such as from substrate 310 or other suitable entity), switch Q11, switch Q12, electrically conductive path 501 (such as one of electrically conductive path 121, electrically conductive path 122, etc.), and output capacitor 235.

Note that the input voltage source 220 may include any number of input capacitors 299 disposed between the ground potential (GND) and the drain node (D) of the switch Q11. Such input capacitors can be mounted on any circuit board.

Although the power converter 400 in FIG. 5 is a buck converter configuration, note that the power converter can be instantiated as any suitable type of voltage converter providing regulation as described herein.

As shown, the switch Q11 is connected in series with switch Q12 between the input voltage source 220 and corresponding ground reference potential or voltage (labeled GND). Via switching of the switches Q11 and Q12 based on control signals 104-1 and 104-2, node NX1 (where X is an integer value and node NX1 is node N11 for X=1; node NX1 is node N21 for X=2; node NX3 is node N13 for X=3; and so on) coupling the source node of switch Q11 and the drain node of switch Q12 provides current 159-1X through the electrically conductive path 501 (such as electrically conductive path 121, electrically conductive path 122, etc.), resulting in generation of the output voltage 223 (a.k.a., VOUT).

In one example, the pulse width modulation controller 260 associated with the controller 540 or other suitable entity controls switching of the switches Q11 and Q12 based on one or more feedback parameters. For example, as previously discussed, the controller 540 can be configured to receive and monitor the output voltage feedback signal 223-FB derived from the output voltage 223 supplied to power the load 118. Via the amplifier 240, the controller 540 compares the output voltage feedback signal 223-FB (such as output voltage 223 or VOUT itself or derivative signal) to the reference voltage 203. As previously discussed, the reference voltage 203 is a desired setpoint in which to control a magnitude of the output voltage 223.

Based on the comparison as provided by amplifier 240, the amplifier 240 produces a respective error voltage 255 based on the difference between the output voltage feedback signal 223-FB and the reference voltage 203. A magnitude of the error voltage 255 (signal) varies depending on the degree to which the magnitude of the output voltage 223 is in or out of regulation (with respect to a reference voltage 203).

As further shown, the PWM controller 260 of the controller 540 controls operation of switching the switches Q11 and Q12 (in phase X) based upon the magnitude of the error voltage 255. For example, if the error voltage 255 indicates that the output voltage 223 (of the power converter 102) is less than a magnitude of the reference voltage 203, the PWM controller 260 increases a duty cycle of activating the high side switch Q11 (thus decreasing a duty cycle of activating the low-side switch Q12) in a respective switching control cycle.

Conversely, if the error voltage 255 indicates that the output voltage 223 (of the power converter 112) is greater than a magnitude of the reference voltage 203, the PWM controller 260 decreases a duty cycle of activating the high side switch Q11 (thus increasing a duty cycle of activating the low-side switch Q12) in a respective switching control cycle.

As is known in the art, the controller 540 can be configured to control each of the switches Q11 and Q12 ON and OFF at different times to prevent short-circuiting of the input voltage 221 (a.k.a., VIN) to the ground reference voltage. For example, when the switch Q11 is activated to an ON state, the switch Q12 is deactivated to an OFF state. Conversely, when the switch Q11 is deactivated to an OFF state, the switch Q12 is activated to an OFF state.

Via variations in the pulse with modulation of controlling the respective switches Q11 and Q12, the controller 140 controls generation of the output voltage 121 such that the output voltage 223 (VOUT) remains within a desired voltage range with respect to the reference voltage 203.

As further discussed herein, the switch circuitry 102-X (also known as power converter circuitry) is duplicated such that a respective instance of the switch circuitry 102-X drives each of the corresponding electrically conductive paths including electrically conductive path 121, electrically conductive path 122, etc. In other words, a respective instance of the switch circuitry 102-X can be implemented to control a flow respective current through each of the electrically conductive paths 121, 122, etc.

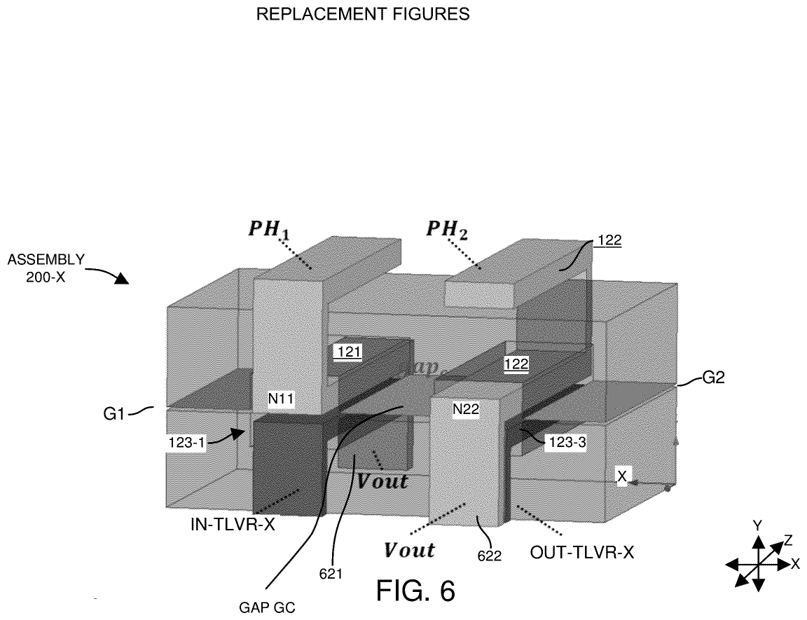

FIG. 6 is an example 3-dimensional diagram illustrating implementation of a transformer assembly as described herein.

In a manner as previously discussed, the switch circuitry 102-11 controls input of current (from a top side of the assembly 200 in this example) to the node ph1 through the electrically conductive path 121 to produce the respective output voltage VOUT, which is outputted via the electrically conductive element 621 from a bottom side of the assembly 200. Switch circuitry 102-12 controls input of current from a top side of the assembly 200 to the node ph2 through the electrically conductive path 122 to produce the respective output voltage VOUT, which is outputted via the electrically conductive element 622 from a bottom side of the assembly 200.

As previously discussed, one or more instances of the assembly 200 can be used to implement a corresponding trans-inductance voltage regulator to produce a respective output voltage VOUT. In this example, the assembly 200-X includes an input to the electrically conductive path 123 such as IN-TLVR-X (such as node N31) and output OUT-TLVR-X (such as node N32) of the electrically conductive path 123.

As further discussed herein, the assembly 200-X can be implemented in different circuits to convert a respective input voltage into an output voltage.

Thus, as shown in FIGS. 4 through 6, examples herein include a new geometrical structure (such as one or more instances of assembly 200) for inductor-based DC-DC converter enabling simple “TLVR line” routing within 2 phases inverse magnetic coupled structure. Additionally, the proposed concepts as discussed herein reduce the peak voltage experienced by the “TLVR line” compared with conventional TLVR implementations as previously discussed.

Note that a TLVR line is an actual electrical connection which enables electrical coupling, resulting in inverse coupling, among different inductors within and outside the same magnetic core.

For example, as previously discussed, FIGS. 2 and 4 represent an example of a basic element which is called Magnetic-Electrical Coupled Inductor (MECI). The MECI or transformer assembly 200 includes one single core where two windings (electrically conductive path 121 and electrically conductive path 122) are powering the same load Vₒᵤₜ from PH₁ and PH₂, moreover an additional winding, the TLVR winding (such as electrically conductive path 123 in the transformer assembly 200-X), is routed around the central leg to provide a respective TLVR circuit path through the assembly 200.

In contrast to a conventional inverse coupled inductor assembly, examples herein include supporting inverse coupling between two-phase enabling a simple TLVR routing as shown in FIG. 4 and FIG. 6. For example, each of FIG. 4 and FIG. 6 illustrates two main two-phases VRM power module implementations using the new MECI magnetic device:
Power stage cooled module (i.e. having heatsink with lowest thermal resistance heatsink to silicon):
   IN_{TLVRi} to OUT_{TLVRi} fiscally are not touching the substrate where PH₁ and PH₂ are sitting
   IN_{TLVRi} to OUT_{TLVRi} winding consist of an integer number of turns around a central leg of a core embedding two inductors (which can be either indirect coupled or non-coupled)
   IN_{TLVRi} to OUT_{TLVRi} are routed to the substrate where Vₒᵤₜ is routed (i.e. the inductive energy is flowing from PHₓ to Vₒᵤₜ)
   IN_{TLVRi} to OUT_{TLVRi} winding is entirely routed within one magnetic structure and enables the electrical coupling between two phases (i.e. there is not the need to connect externally to concatenate the induced voltage on the auto-inductance)
Inductor cooled module (i.e. having heatsink with lowest thermal resistance heatsink to inductors' windings)
   IN_{TLVRi} to OUT_{TLVRi} pad lay on the substrate where PH₁ and PH₂ are sitting
   IN_{TLVRi} to OUT_{TLVRi} winding consist of an integer number of turns around a central leg of a core embedding two inductors magnetically indirectly coupled
   IN_{TLVRi} to OUT_{TLVRi} are routed to the substrate where Vₒᵤₜ is routed (i.e. the inductive energy is flowing from PHₓ to Vₒᵤₜ)
   IN_{TLVRi} to OUT_{TLVRi} winding is entirely routed within one magnetic structure and enables the electrical coupling between two phases (i.e. there is no need for complicated external routing to concatenate the induced voltage on the auto-inductance)

In both scenarios, it is noted that the max voltage reflected to the “TLVR line” depends on the amount of module connected, input and output voltage and coupling coefficient of the inversed magnetic coupled inductor.

In contrast to a conventional trans-inductance voltage regulator circuit, examples herein include or allow the reduction of the maximum voltage concatenated with the “TLVR connection” because in the structure (assembly 200) proposed in FIGS. 2 and 4, the maximum voltage experienced by “TLVR connection” depends on number of phases, input voltage, output voltage and in addition is also depending on the coupling of the magnetic coupled inductors.

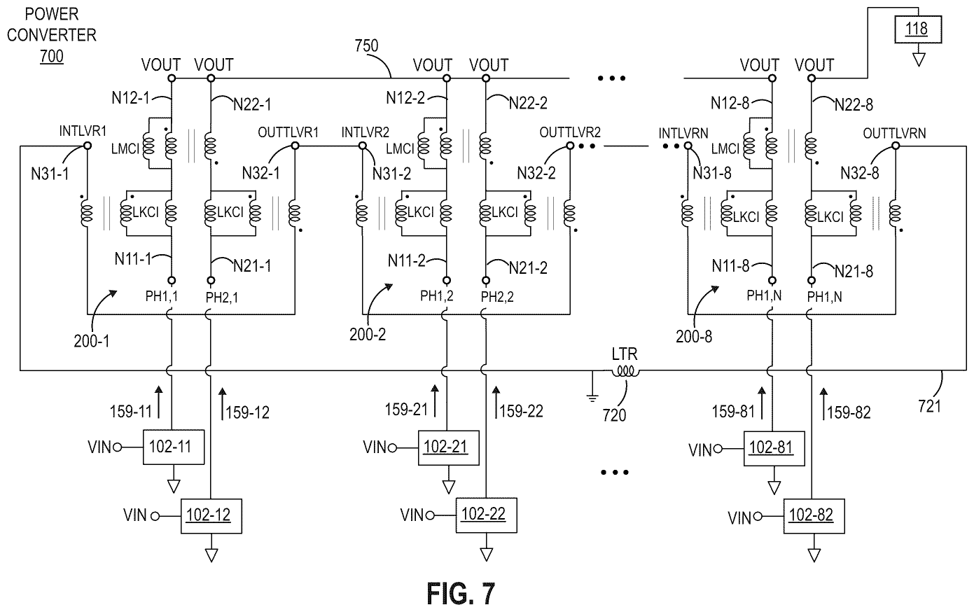

As further shown in FIG. 7, multiple instances of the assembly 200-X can be connected in series to implement a respective trans-inductance voltage regulator circuit.

More specifically, FIG. 7 is an example diagram illustrating a respective trans-inductance voltage regulator circuit as described herein.

As shown in FIG. 7, the proposed Magnetic-Electrical 2 phases Coupled inductor (such as one or more instances of the assembly 200) can be connected between multiple instances of the Magnetic-Electrical 2 phases Coupled inductor, as show in power converter 700.

In this example, power converter 700 includes multiple instances of the transformer assembly 200-X to convert a respective input voltage VIN (such as a DC voltage) into an output voltage VOUT (such as a DC voltage). For example, the power converter 700 includes any number of transformer assemblies such as a transformer assembly 200-1, a transformer assembly 200-2, . . . , and transformer assembly 200-8. Thus, implementation of 8 instances of the transformer assembly 200-X is shown by way of nonlimiting example.

As previously discussed, the transformer assembly 200-1 (first instance of transformer assembly 200) includes multiple electrically conductive paths between corresponding nodes. For example, the transformer assembly 200-1 includes a respective electrically conductive path (instance of electrically conductive path 121) between the node N11-1 and the node N12-1; the transformer assembly 200-1 includes a respective electrically conductive path (instance of electrically conductive path 122) between the node N21-1 and the node N22-1; the transformer assembly 200-1 includes a respective TLVR electrically conductive path (instance of electrically conductive path 123) between the node N31-1 and the node N32-1. The switch circuitry 102-11 (first instance of the switch circuitry shown in FIG. 5) controls the flow of current 159-11 through the electrically conductive path between the node N11-1 and the node N12-1 to produce the output voltage. In a similar manner, in parallel with the switch circuitry 102-11, the switch circuitry 102-12 (second instance of the suit circuitry that shown in FIG. 5) controls the corresponding current 159-12 through the electrically conductive path disposed between the node N21-1 and the node N22-1. The electrically conductive element 750 provides connectivity of the node N12-1 to the node N22-1 such that the combination of the output current from the node N12-1 and node N22-1 is supplied to the corresponding load 118.

The power converter 700 in FIG. 7 also includes the transformer assembly 200-2. The transformer assembly 200-2 (second instance of transformer assembly 200) includes multiple electrically conductive paths between corresponding nodes. For example, the transformer assembly 200-2 includes a respective electrically conductive path (instance of 121) between the node N11-2 and the node N12-2; the transformer assembly 200-2 includes a respective electrically conductive path (instance of 122) between the node N21-2 and the node N22-2; the transformer assembly 200-2 includes a respective TLVR electrically conductive path (instance of 123) between the node N31-2 and the node N32-2. The switch circuitry 102-21 (such as a third instance of the switch circuitry in FIG. 5) controls the flow of current 159-21 through the electrically conductive path between the node N11-2 and the node N12-2 to produce the output voltage. In a similar manner, in parallel with the switch circuitry 102-21, the switch circuitry 102-22 (such as a fourth instance of the switch circuitry in FIG. 5) controls the corresponding current 159-22 through the electrically conductive path disposed between the node N21-2 and the node N22-2. The electrically conductive element 750 provides connectivity of the node N12-2 to the node N22-2 such that the combination of the output current from the node N12-2 and node N22-2 also supply corresponding output current to the load 118.

The power converter 700 in FIG. 7 also includes the transformer assembly 200-8. The transformer assembly 200-8 (eighth instance of transformer assembly 200) includes multiple electrically conductive paths between corresponding nodes. For example, the transformer assembly 200-8 includes a respective electrically conductive path (instance of 121) between the node N11-8 and the node N12-8; the transformer assembly 200-8 includes a respective electrically conductive path (instance of 122) between the node N21-8 and the node N22-8; the transformer assembly 200-8 includes a respective TLVR electrically conductive path (instance of 123) between the node N31-8 and the node N32-8. The switch circuitry 102-81 controls the flow of current 159-81 through the electrically conductive path between the node N21-8 and the node N12-8 to produce the output voltage. In a similar manner, in parallel with the switch circuitry 102-81, the switch circuitry 102-82 controls the corresponding current 159-82 through the electrically conductive path disposed between the node N21-8 and the node N22-8. The electrically conductive element 750 provides connectivity of the node N12-8 to the node N22-8 such that the combination of the output current from the node N12-8 and node N22-8 is supplied to the corresponding load 118.

As further shown in this example, each of the pairs of phases associated with the respective instance of transformer assembly operate to convert the input voltage Vin into the corresponding output voltage Vout to power the load 118. The serial connectivity of the TLVR windings is achieved via: i) a first connectivity of the node N32-1 to the node N31-2 via a corresponding electrically conductive element 750; second connectivity of the node, ii) a second connectivity of the node N32-2 to the node N31-3 via a corresponding electrically conductive element 750; . . . , viii) an eighth connectivity of the node N32-8 to the node N31-1 via a corresponding series circuit path 721. Note that the series circuit path 721 includes corresponding inductor 720.

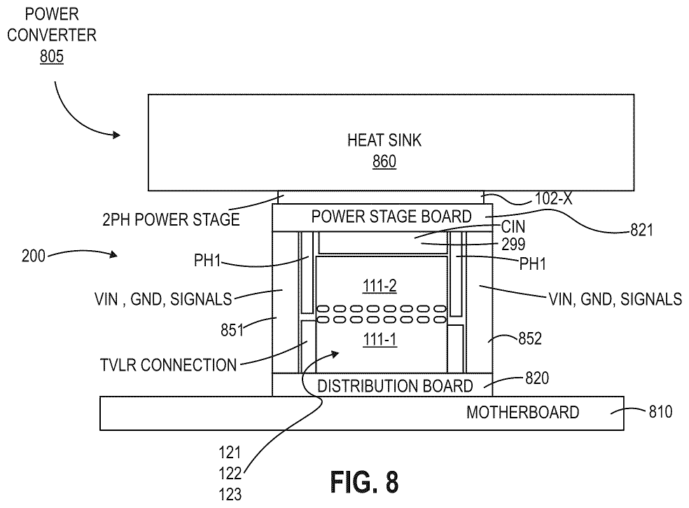

FIG. 8 is an example diagram illustrating implementation of a respective trans-inductance voltage regulator circuit as described herein.

As previously explained the proposed Magnetic-Electrical Coupled Inductor (such as assembly 200) presents two phases magnetically coupled, such coupling reduced the actual voltage concatenated by each auto-inductance forming the magnetic inversed coupling inductor. Consider that the actual voltage reflected to the “TLVR connection” depends on the coupling coefficient of the magnetic coupled inductor and therefore, when M Magnetic-Electrical Coupled Inductor are connected, the maximum voltage reflected to the TLVR line is lower than (Vᵢₙ−Vₒᵤₜ)2M. In general, in a two phase implementation, when both phases have high side on (i.e. powering from input voltage Vᵢₙ) the maximum voltage reflected to the TLVR winding is lower than (Vᵢₙ−Vₒᵤₜ)2 and its value depends on the coupling coefficient of the magnetic coupled inductor.

Within the connection among all the MECI devices can be added an additional inductor, called transient inductor 720 such as Lₜᵣ, to optimize the current slew rate.

Having a lower voltage reflected to the TLVR windings has several benefits. Specifically, as discussed herein, it reduces both winding and core loss by reducing the voltage-time area (lower ripple hence lower flux swing and lower RMS current during steady-state operation) for the transient inductor Lₜᵣ (i.e. when fiscally built with magnetic material). Additionally it simplifies the manufacturability of the transformer and of the overall system as a lower induced voltage requires lower clearance and creepage distances and easier to achieve electrical isolation.

The coupling coefficient, in a magnetic coupled inductor structure, can be tailored by modulating lateral gap G1 (gapₗ) in G2 and central gap GC (gap_{c}), meaning that the maximum voltage reflected to the “TLVR line” depends on the actual physical dimension of the lateral and central gaps, therefore we can identify two conditions:
gape_{c}>0: in this case inverse coupling is ensured between the two phase and therefore the maximum voltage reflected to the TLVR line is lower than (Vᵢₙ−Vₒᵤₜ)2
gap_{c}=0: the two inductors are not magnetically coupled and therefore the inductors are only electrically coupled. In this specific case the maximum voltage experienced by the “TLVR line” is (Vᵢₙ−Vₒᵤₜ)2.

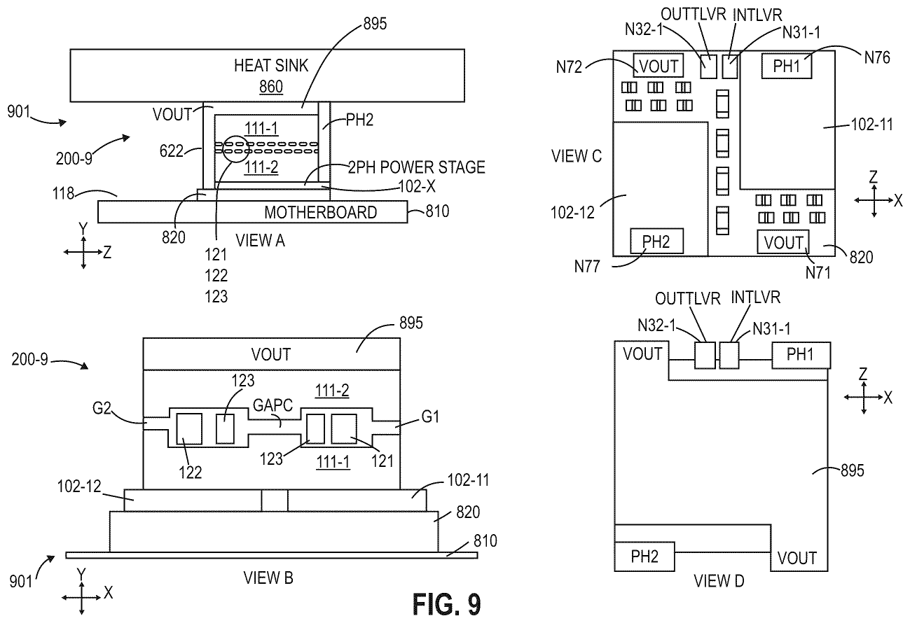

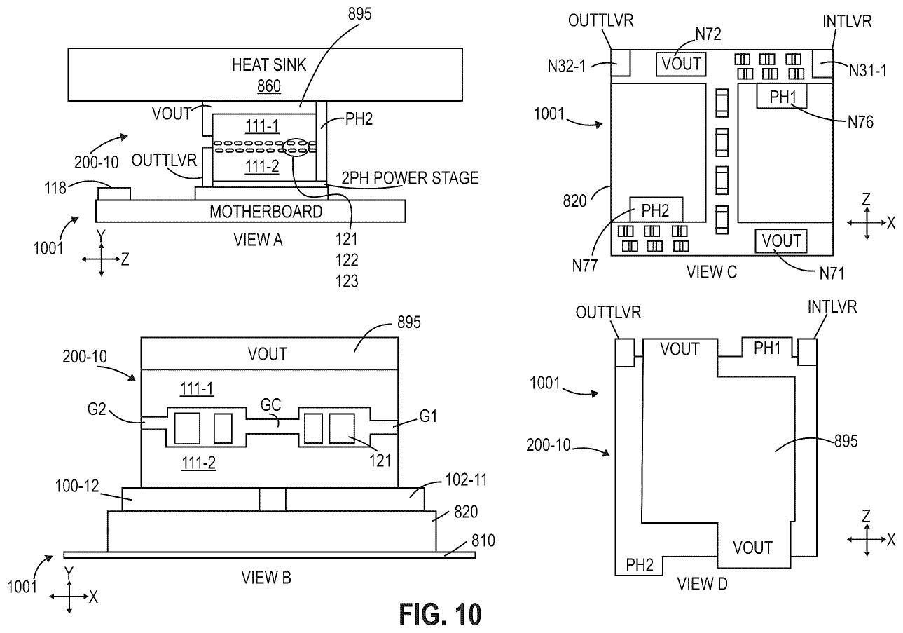

As previously discussed, the proposed Magnetic-Electrical Coupled Inductor can be implemented in a respective power converter system, where typically high transient performance and high current density is required. In this section are shown two type of implementation: the first one is a power stage (such as FIG. 9) cooled voltage regulation module whereas the second one (such as FIG. 10) is an inductor cooled voltage regulation module.

Note that the 2 phase buck converter in FIG. 8 can be implemented with power stage cooled implementation having TLVR winding not connected to power stage PCB level

As more particularly shown in FIG. 8, the corresponding power converter 805 (power supply assembly) can be configured to include a respective transformer assembly 200 disposed between the substrate 821 such as a power stage board including switch circuitry (a FIG. 5) and the substrate 820 such as a so-called distribution circuit board.

The substrate 820 can be connected or coupled to the corresponding substrate 800 such as a motherboard. In one example, the substrate 810 provides the input voltage, ground reference voltage, and other signals through the substrate 820 and electrically conductive paths 851 and/or electrically conductive paths 852. The corresponding substrate 821 can be configured to include one or more instances of the switch circuitry 102-X as previously discussed to control a respective flow of current into the node ph1 and node ph2.

If desired, the power converter 805 includes only electrically conductive paths 851 or electrically conductive paths 852.

Thus, in one example, a power supply implementation such as power converter 805 may include a combination of the magnetically permeable material 111 such as magnetically permeable material 111-1 and magnetically permeable material 111-2, the first electrically conductive path 121, the second electrically conductive path 122, and the third electrically conductive path 123 disposed in the transformer assembly 200. The power converter 805 or power supply includes a substrate 820 such as a distribution board to which the corresponding assembly 200 is affixed.

As further shown, the example power converter 805 and corresponding assembly can be configured to include a substrate 821 (such as a first circuit board) and corresponding one or more instances of switch circuitry 102-X to control flow of current through the first electrically conductive path and the second electrically conductive path of the transformer assembly 200 in a manner as previously discussed.

Yet further, as previously discussed, the power converter assembly such as power converter 805 can be configured to include substrate 820 such as a second circuit board. The substrate 820 such as a second circuit board (such as a distribution board) provides connectivity of the assembly 200 to the substrate 810. In such an instance, a combination of the magnetically permeable material (such as magnetically permeable material 111-1 and magnetically permeable material 111-2), the first electrically conductive path 121, the second electrically conductive path 122, and the third electrically conductive path 123 are disposed between the first circuit board (substrate 820) and the second circuit board (substrate 821).

As further shown, the power converter 805 can be configured to include a respective heatsink 860 coupled to the substrate 821 and/or corresponding switch circuitry 102-X. If desired, the capacitors 299 can be disposed on the substrate 821 between the substrate 821 and the magnetically permeable material 111-2.

As mentioned, one of the main benefits of the proposed Magnetic-Electrical Coupled Inductor (assembly 200) is the simple TLVR winding routing, as reported in FIG. 6. Such benefit can be exploited for power stage TOP side cooled, where normally the half-bridge (HB) is attached to a heat spreader to improve silicon thermal performance and therefore system performance. Considering a classical TLVR implementation, the TLVR windings of a single elemental transformer needs to be routed at the level of the phase node PCB, which means an increase of complexity when vertical power flow is required. For these reasons our proposed Magnetic-Electrical Coupled Inductor overcomes such routing limitation when power stage cooled implementation is required.

A TOP side cooled power stage is typically designed with two horizontal PCB and with vertical connections:
Distribution board 820 is connected to the mother board (i.e. where is sitting Vin, Vout of the converter) and to the TLVR connection
Power stage board 102-x, where HB is placed and is connected thermally to a heat sink 860 and is not connected to the TLVR connection
Vertical routing such as via electrically conductive paths 851 and/or 852: of digital/analog signals Vin and GND displaced on two sides (i.e. to keep symmetrical power flow from Vin to Vout for both phases, as shown in FIG. 8. If desired, to overcome the need of two vertical connection in FIG. 8 can be modified to include only one side vertical connection where the Vin connection symmetry between the two phases is ensured by the power stage board layout (i.e. same resistance path of Vin connection from one side Vin connection).

Another example herein includes a two-phase buck converter with inductor cooled implementation having TLVR winding routed within the magnetic core.

As mentioned, one of the main benefits of the proposed Magnetic-Electrical Coupled Inductor is the simple TLVR winding routing within a two-phase implementation. Such benefit can be exploited for inductor cooled two phase power buck converters, where normally the windings of the inductor are attached to a heat sink, wherein the power stage is cooled through the winding inductive to improve silicon thermal performance and therefore system performance.

In a conventional TLVR implementation, respective TLVR windings of a single elemental transformer need to be routed externally the magnetic device which means an increase of complexity due to the routing between the two phases. In contrast to conventional techniques, the transformer assembly 200 overcomes such routing limitations.

An inductor cooled implementation may be designed with one horizontal PCB and a two phase MECI inductor as show in FIGS. 9 and 10:
PCB module is connected to the mother board (i.e. where is sitting Vin, Vout of the converter) and to the TLVR connection
Two-phases inductor: realized in one core having indirect magnetic coupling and enabling electric coupling among different MECI magnetic device, as proposed in FIG. 4c).

FIGS. 9 and 10 are shown two different implementations where the main difference is given by the TLVR routing position (i.e. dependent on the actual PCB module bottom side footprint to the motherboard).

FIG. 9 is an example diagram illustrating multiple views of a respective transformer assembly and/or power converter assembly as described herein.

More specifically, view A (along the x-axis) of FIG. 9 is an example first side view diagram of a power converter assembly 901 and respective transformer assembly 200-9 as described herein. View B (along z-axis) of FIG. 9 is an example second side view diagram of the power converter assembly 901 and corresponding transformer assembly 200-9 as described herein. View C (along the y-axis) of FIG. 9 is an example diagram illustrating a first circuit board and corresponding circuit board layout associated with the power converter assembly 901 and corresponding transformer assembly 200-9 as described herein. View D (along the y-axis) of FIG. 9 is an example diagram illustrating a top view of a transformer assembly 200-9 as described herein.

In this example, view A of FIG. 9 illustrates the transformer assembly 200-9 (such as an instance of the assembly 200-X) disposed in a respective power converter 901. The transformer assembly 200-9 is disposed between the substrate 820 and the layer of electrically conductive material 895. One or more instances of switch circuitry 102-X is disposed in or on the substrate 820. As previously discussed, the switch circuitry 102-X controls conveyance of current through the corresponding electrically conductive paths 121 and 122 of the transformer assembly 200-9.

As further shown, the substrate 820 is coupled to the substrate 810 (such as a so-called mother board). The substrate 820 (such as a circuit board) can be configured to receive the input voltage and a ground reference voltage as described herein from the mother board 810. As previously discussed, via switching, the switch circuitry 102-X disposed on the substrate 820 receives and uses the received input voltage and a ground reference voltage to control conveyance of a respective current through the electrically conductive paths 121 and 122 to produce the respective output voltage.

Yet further in this example, the power converter assembly 901 includes a respective layer of electrically conductive material 895 disposed on a top side of the transformer assembly 200-9. The layer of electrically conductive material 895 is disposed between the magnetically permeable material 111-2 and the heatsink 860. The benefit of fabricating the transformer assembly 200-9 and corresponding power converter assembly 901 to include the layer of electrically conductive material 895 and corresponding electrically conductive elements from the layer of electrically conductive material 895 to the electrically conductive paths 121, 122, 123, is upward conveyance of a respective heat generated by one or more of the following components such as transformer assembly 200-9, switch circuitry 102-X, substrate 820, substrate 810, electrically conductive path 121, electrically conductive path 122, electrically conductive path 123, etc., to the heatsink 860. The heatsink 860 dissipates any received heat in an upward direction to the air or other medium so that the power converter 901 is not damaged by excessive heat.

As previously discussed, the electrically conductive path 121 and the electrically conductive path 122 output the corresponding output voltage used to power a respective load 118. The load 118 may be coupled to any suitable entity such as the substrate 810, substrate 820, etc. The power converter assembly 901 and corresponding transformer assembly 200-9 can be configured to include a respective electrically conductive path from the node N12 up to the layer of electrically conductive material 895. Additionally, the power converter assembly 901 and corresponding transformer assembly 200-9 can be configured to include a respective electrically conductive path from the node N22 up to the layer of electrically conductive material 895.

Yet further, also in accordance with FIG. 6, the transformer assembly 200-9 of FIG. 9 can be configured to include a respective electrically conductive element 621 coupling the node N12 of the electrically conductive path 121 to the corresponding substrate 820. The substrate 820 includes a respective one or more circuit paths to convey the received output voltage to the substrate 810 and corresponding load 118.

In a similar manner, as shown in FIG. 6, the transformer assembly 200-9 can be configured to include a respective electrically conductive element 622 coupling the node N22 of the electrically conductive path 122 to the corresponding substrate 820. Substrate 820 further can be configured to include a respective circuit path to convey the received output voltage through the substrate 820 to the substrate 810 corresponding load 118.

Thus, although the output voltage Vout may be used to power a respective load 118 disposed on the substrate 810 or substrate 820, or other suitable entity, conveyance of the output voltage to the layer of electrically conductive material 895 provides a good thermally conductive path in which to convey heat from one or more of the substrate 810, substrate 820, switch circuitry 102-X, transformer assembly 200-9, up to the layer of electrically conductive material 895 and corresponding heatsink 860. As previously as discussed, the heat received by the heatsink 860 is dissipated above or to the side of it.

View B of the power converter assembly 901 in FIG. 9 illustrates that the switch circuitry associated with the power converter assembly 901 can include a first instance of switch circuitry 102-11 and switch circuitry 102-12. As previously discussed in FIG. 4, the switch circuitry 102-11 controls respective flow of current 159-11 through the electrically conductive path 121 of the transformer assembly 200-9 to produce the respective output voltage. The switch circuitry 102-12 controls respective flow of current 159-12 through the electrically conductive path 122 of transformer assembly 200-9 to produce the respective output voltage.

View C of FIG. 9 (top view of the corresponding substrate 820) illustrates placement of different components on the substrate 820 to support generation of the output voltage. For example, via an electrically conductive element 621 or other suitable entity, the node N71 of the substrate 820 receives the output voltage from the node N12 of the electrically conductive path 121; via the electrically conductive element 622 or other suitable entity, the node N72 of the substrate 820 receives the output voltage from the node N22 output from the electrically conductive path 122. Node N76 provides or outputs the corresponding current 159-11 through a respective electrically conductive element to the node N11 of the electrically conductive path 121. Node N77 provides the corresponding current 159-12 through a respective electrically conductive element to the node N21 of the electrically conductive path 122. As previously discussed, the controlled flow of current results in generation of the corresponding output voltage Vout.

As further shown, note that the power converter assembly 901 includes a respective electrically conductive element extending between the node N31 of the electrically conductive path 123 to the corresponding node N31-1 (such as surface pad) disposed on the substrate 820. Additionally, the power converter assembly 901 includes a respective electrically conductive element extending between the node N32 of the electrically conductive path 123 to the corresponding node N32-1 disposed on the substrate 820. Accordingly, both ends of the electrically conductive path 123 are connected in this example to the corresponding substrate 820 at different nodes. The corresponding electrically conductive elements provide conveyance of output current and output voltage from the electrically conductive paths to the node N32-1 and the node N32-2.

View D of FIG. 9 illustrates the layer of electrically conductive material 895 as well as locations of corresponding electrically conductive elements along the y-axis.

FIG. 10 is an example diagram illustrating multiple views of a respective transformer assembly and/or power converter assembly as described herein.

View A (along the x-axis) of FIG. 10 is an example first side view diagram of a power converter assembly 1001 and respective transformer assembly 200-10 as described herein. View B (along z-axis) of FIG. 10 is an example second side view diagram of the power converter assembly 1001 and corresponding transformer assembly 200-10 as described herein. View C (along the y-axis) of FIG. 10 is an example diagram illustrating a first circuit board and corresponding circuit board layout associated with the power converter assembly 1001 and corresponding transformer assembly 200-10 as described herein. View D (along the y-axis) of FIG. 10 is an example diagram illustrating a top view of a transformer assembly 200-10 as described herein.

In this example, view A illustrates the transformer assembly 200-10 (such as an instance of the assembly 200-X) disposed in a respective power converter 1001. The transformer assembly 200-10 none is disposed between the substrate 820 and the layer of electrically conductive material 895. One or more instances of switch circuitry 102-X is disposed in or on the substrate 820. As previously discussed, the switch circuitry 102-X controls conveyance of current through the corresponding electrically conductive paths 121 and 122 of the transformer assembly 200-10.

As further shown, the substrate 820 is coupled to the substrate 810 (such as a so-called mother board). The substrate 820 (such as a circuit board) can be configured to receive the input voltage and a ground reference voltage as described herein from the mother board 810. As previously discussed, via switching, the switch circuitry 102-X disposed on the substrate 820 receives and uses the received input voltage and a ground reference voltage to control conveyance of a respective current through the electrically conductive paths 121 and 122.

Yet further in this example, the power converter assembly 1001 includes a respective layer of electrically conductive material 895 disposed on a top side of the transformer assembly 200-10. The layer of electrically conductive material 895 is disposed between the magnetically permeable material 111-2 and the heatsink 860. The benefit of fabricating the transformer assembly 200-10 and corresponding power converter assembly 1001 to include the layer of electrically conductive material 895 and corresponding electrically conductive elements from the layer of electrically conductive material 895 to the electrically conductive paths 121, 122, 123, is conveyance of respective heat generated by one or more of the following components such as transformer assembly 200-10, switch circuitry 102-X, substrate 820, substrate 810, electrically conductive path 121, electrically conductive path 122, electrically conductive path 123, etc., to the heatsink 860. The heatsink 860 dissipates any received heat in an upward direction or side way direction so that the power converter 1001 is not damaged by excessive heat.

As previously discussed, the electrically conductive path 121 and the electrically conductive path 122 output the corresponding output voltage used to power a respective load 118. The load 118 may be coupled to any suitable entity such as the substrate 810, substrate 820, etc. The power converter assembly 1001 and corresponding transformer assembly 200-10 can be configured to include a respective electrically conductive path from the node N12 up to the layer of electrically conductive material 895. Additionally, the power converter assembly 1001 and corresponding transformer assembly 200-10 can be configured to include a respective electrically conductive path from the node N22 up to the layer of electrically conductive material 895.

Yet further, also in accordance with FIG. 6, the transformer assembly 200-10 of FIG. 10 can be configured to include a respective electrically conductive element 621 coupling the node N12 of the electrically conductive path 121 to the corresponding substrate 820. The substrate 820 includes a respective circuit path to convey the received output voltage to the substrate 810 and corresponding load 118. In a similar manner, as shown in FIG. 6, the transformer assembly 200-10 can be configured to include a respective electrically conductive element 622 coupling the node N22 of the electrically conductive path 122 to the corresponding substrate 820. Substrate 820 further can be configured to include a respective circuit path to convey the received output voltage through the substrate 820 to the substrate 810 corresponding load 118.

Thus, although the output voltage Vout may be used to power a respective load 118 disposed on the substrate 810 or substrate 820, or other suitable entity, conveyance of the output voltage to the layer of electrically conductive material 895 provides a good thermally conductive path in which to convey heat from one or more of the substrate 810, substrate 820, switch circuitry 102-11, switch circuitry 102-12, transformer assembly 200-10, up to the layer of electrically conductive material 895 and corresponding heatsink 860. As previously as discussed, the heat received by the heatsink 860 is dissipated above it.

View B of the power converter assembly 1001 in FIG. 10 illustrates that the switch circuitry associated with the power converter assembly 1001 can include a first instance of switch circuitry 102-11 and switch circuitry 102-12. As previously discussed in FIG. 4 and other FIGS., the switch circuitry 102-11 controls respective flow of current 159-11 through the electrically conductive path 121 of the transformer assembly 200-10 to produce the respective output voltage. The switch circuitry 102-12 controls respective flow of current 159-12 through the electrically conductive path 122 of transformer assembly 200-10 to produce the respective output voltage.

View C of FIG. 10 (top view of the corresponding substrate 820) illustrates placement of different components on the substrate 820 to support generation of the output voltage. For example, via an electrically conductive element 621 or other suitable entity, the node N71 of the substrate 820 receives the output voltage from the node N12 of the electrically conductive path 121; via the electrically conductive element 622 or other suitable entity, the node N72 of the substrate 820 receives the output voltage from the node N22 output from the electrically conductive path 122. Node N76 provides or outputs the corresponding current 159-11 through a respective electrically conductive element to the node N11 of the electrically conductive path 121. Node N77 provides the corresponding current 159-12 through a respective electrically conductive element to the node N21 of the electrically conductive path 122. As previously discussed, the controlled flow of current results in generation of the corresponding output voltage Vout.

As further shown, note that the power converter assembly 1001 includes a respective electrically conductive element extending between the node N31 of the electrically conductive path 123 to the corresponding node N31-1 (such as surface pad) disposed on the substrate 820. Additionally, the power converter assembly 1001 includes a respective electrically conductive element extending between the node N32 of the electrically conductive path 123 to the corresponding node N32-1 disposed on the substrate 820. Accordingly, both ends of the electrically conductive path 123 are connected in this example to the corresponding substrate 820 at different nodes.

View D of FIG. 10 illustrates the layer of electrically conductive material 895 as well as locations of corresponding electrically conductive elements along the y-axis.

Note again that techniques herein are well suited for use in circuit assembly applications such as those providing power delivery to one or more loads. However, it should be noted that the disclosure of matter herein is not limited to use in such applications and that the techniques discussed herein are well suited for other applications as well.

While this invention has been particularly shown and described with references to preferred aspects thereof, it will be understood by those skilled in the art that various changes in form and details may be made therein without departing from the spirit and scope of the present application as defined by the appended claims. Such variations are intended to be covered by the scope of this present application. As such, the foregoing description in the present disclosure is not intended to be limiting. Rather, any limitations to the invention are presented in the following claims.

We claim:

1. An apparatus comprising:
a first electrically conductive path extending through magnetically permeable material;
a second electrically conductive path extending through the magnetically permeable material, the second electrically conductive path inductively coupled to the first electrically conductive path via the magnetically permeable material; and
a third electrically conductive path disposed in the magnetically permeable material and extending along the first electrically conductive path and the second electrically conductive path.

2. The apparatus as in claim 1, wherein a first portion of the third electrically conductive path is inductively coupled to the first electrically conductive path; and
wherein a second portion of the third electrically conductive path is inductively coupled to the second electrically conductive path.

3. The apparatus as in claim 1, wherein a first portion of the third electrically conductive path and the first electrically conductive path is a first transformer of a trans-inductance voltage regulator circuit; and
wherein a second portion of the third electrically conductive path and the second electrically conductive path is a second transformer of the trans-inductance voltage regulator circuit.

4. The apparatus as in claim 3 further comprising:
first switch circuitry operative to control a magnitude of first current supplied into a first axial end of the first electrically conductive path, the first current conveyed by the first electrically conductive path to a second end of the first electrically conductive path; and
second switch circuitry operative to control a magnitude of second current supplied into a first axial end of the second electrically conductive path, the second current conveyed through the second electrically conductive path to a second end of the second electrically conductive path.

5. The apparatus as in claim 4 further comprising:
an electrically conductive element coupling the second axial end of the first electrically conductive path to the second axial end of the second electrically conductive path, the electrically conductive element outputting an output voltage.

6. The apparatus as in claim 1, wherein the first electrically conductive path is a first inductor;
wherein the second electrically conductive path is a second inductor; and
wherein the first inductor is inversely coupled with respect to the second inductor.

7. The apparatus as in claim 1, wherein the magnetically permeable material includes a gap disposed in a volume of the magnetically permeable material disposed between the first electrically conductive path and the second electrically conductive path.

8. The apparatus as in claim 7, wherein the gap is a void.

9. The apparatus as in claim 1 further comprising:
a first gap disposed in the magnetically permeable material, the first gap disposed in a first volume between the first electrically conductive path and the second electrically conductive path;
a second gap disposed in the magnetically permeable material, the first electrically conductive path disposed in a second volume between the first gap and the second gap; and
a third gap disposed in the magnetically permeable material, the second electrically conductive path disposed between the first gap and the third gap.

10. The apparatus as in claim 1, wherein a combination of the magnetically permeable material, the first electrically conductive path, the second electrically conductive path, and the third electrically conductive path are disposed in a transformer assembly, the apparatus further comprising:
a first substrate; and
wherein the transformer assembly is affixed to the first substrate.

11. The apparatus as in claim 10, wherein the transformer assembly includes first switch circuitry on a second substrate, the first switch circuitry operative to control flow of first current through the first electrically conductive path and the second electrically conductive path.

12. The apparatus as in claim 11, wherein the combination of the magnetically permeable material, the first electrically conductive path, the second electrically conductive path, and the third electrically conductive path are disposed between the first substrate and the second substrate.

13. The apparatus as in claim 12 further comprising a heatsink coupled to the second substrate.

14. The apparatus as in claim 1, wherein the first electrically conductive path is disposed in parallel with the second electrically conductive path, the apparatus further comprising:
first switch circuitry operative to control first current to flow in a first direction through the first electrically conductive path;
second switch circuitry operative to control second current to flow in a second direction through the second electrically conductive path; and
wherein the second direction is substantially opposite the first direction.

15. The apparatus as in claim 14 further comprising:
an electrically conductive element operative to convey a summation of the first current and the second current to a load.

16. The apparatus as in claim 1, wherein the magnetically permeable material is operable to support conveyance of first magnetic flux around a combination of the first electrically conductive path and the second electrically conductive path;
where the magnetically permeable material is operative to support conveyance of second magnetic flux around a combination of the first electrically conductive path and a first portion of the third electrically conductive path, the second magnetic flux passing between first electrically conductive path and the second electrically conductive path; and
where the magnetically permeable material is operative to support conveyance of third magnetic flux around a combination of the second electrically conductive path and a second portion of the third electrically conductive path, the third magnetic flux passing between the first electrically conductive path and the second electrically conductive path.

17. The apparatus as in claim 1 further comprising:
a substrate;
first switch circuitry affixed to the substrate, the first switch circuitry operative to control flow of first current through the first electrically conductive path; and
second switch circuitry affixed to the substrate, the second switch circuitry operative to control flow of second current through the second electrically conductive path.

18. The apparatus as in claim 17 further comprising:
a first electrically conductive element extending between a first axial end of the first electrically conductive path to the first switch circuitry;
a second electrically conductive element extending between a second axial end of the first electrically conductive path to the substrate;
a third electrically conductive element extending between the first axial end of the second electrically conductive path to the second switch circuitry; and
a fourth electrically conductive element extending between the second axial end of the second electrically conductive path to the substrate.

19. The apparatus as in claim 1, wherein a combination of the magnetically permeable material, first electrically conductive path, the second electrically conductive path, and the third electrically conductive path are disposed in a transformer assembly, the apparatus further comprising:
a substrate to which the transformer assembly is affixed;
a layer of electrically conductive material;
wherein transformer assembly is disposed between the substrate and the layer of electrically conductive material.

20. The apparatus as in claim 19 further comprising:
an electrically conductive element extending between the layer of electrically conductive material and the substrate, the electrically conductive element conveying a respective output voltage produced by the first electrically conductive path and the second electrically conductive path.

21. A method comprising:
receiving magnetically permeable material;
fabricating a first electrically conductive path to extend through magnetically permeable material;
fabricating a second electrically conductive path to extend through the magnetically permeable material, the second electrically conductive path inductively coupled to the first electrically conductive path via the magnetically permeable material; and
fabricating a third electrically conductive path disposed in the magnetically permeable material, the third electrically conductive path operable to extend along the first electrically conductive path and the second electrically conductive path.
